(19) United States
(12) Patent Application Publication
(10) Pub. No.: US 2011/0229628 A1
(43) Pub. Date: Sep. 22, 2011

(54) METHOD OF CREATING A STRUCTURED SURFACE IN THE FIELD OF THE PRINTING INDUSTRY

(75) Inventors: Martin Schmitt-Lewen, Heidelberg (DE); Joachim Sonnenschein, Muehltal (DE); Edgar Dörsam, Obertshausen (DE); Thorsten Euler, Darmstadt (DE); Martin Haas, Darmstadt (DE); Evgeny Kurmakaev, Obertshausen (DE)

(73) Assignee: HEIDELBERGER DRUCKMASCHINEN AKTIENGESELLSCHAFT, Heidelberg (DE)

(21) Appl. No.: 13/051,159

(22) Filed: Mar. 18, 2011

(30) Foreign Application Priority Data
Mar. 18, 2010 (DE) 10 2010 011 848.6

(51) Int. Cl. B41M 3/14; B05C 11/00

(52) U.S. Cl. 427/7; 118/600; 118/46

(57) ABSTRACT

A method for creating a structured surface or a safety or decorative feature based thereon in a process of the printing industry wherein a liquid, preferably ink or varnish, and particles, preferably pearlescent pigments or a material having a similar effect are applied to a substrate. The liquid is provided with a surface structure and is characterized by a creation of a random surface structure, in particular a structure of mountains and valleys, of the liquid and by the creation of a random particle distribution, preferably a random particle orientation, by blowing a gas such as air onto the unhardened liquid which may be heated if desired. The surface that is thus created has a unique structure that is discernible by the human eye or detectable by camera and may, for instance, have a light/dark change.

### CROSS-REFERENCE TO RELATED APPLICATION

This application claims the priority, under 35 U.S.C. §119, of German application DE 10 2010 011 848.6, filed Mar. 18, 2010; the prior application is herewith incorporated by reference in its entirety.

### BACKGROUND OF THE INVENTION

### Field of the Invention

The present invention relates to a method of creating a structured surface in the field of the printing industry, wherein a liquid and particles are applied to a substrate and the liquid provided with a surface structure. Furthermore the present invention relates to a machine for carrying out such a method.

The creation of optical effects on printed products or products of the packaging industry for decorative reasons or for reasons of safety (as a safeguard against counterfeiting or manipulation of merchandise) is known from the prior art. Examples are holograms or guilloches. In addition to applying printing inks and varnishes to create such features, the use of particles is becoming increasingly common. Such particles themselves may carry safety features such as a microbarcode or they may create a special effect such as a gloss or glitter which makes the product difficult to counterfeit because it cannot easily be copied. Frequently, a number of safety features are combined to increase the protection against counterfeiting, as it is known, for example in currency. In addition, there is an increasing demand for new safety features because one specific safety feature guarantees protection of a product against counterfeiting or plagiarism only for a short period of time. In a manner of speaking, there is a “race” between manufacturers and counterfeiters.

Published, non-prosecuted German patent application DE 10 2006 057 507 A1, corresponding to U.S patent publication No. 20100072739, discloses an optically variable and haptically detectable safety element for protecting merchandise against counterfeiting and a method of creating such a safety element. Plate-shaped effect pigments are used in a substrate coating that may be hardened. The pigments are preferably aligned in parallel with the substrate already during the printing or coating process. The coating may have a structure of elevations and depressions to improve the haptics, for example created in a complex embossing process, and may have a base color. Lithographic offset printing and screen printing are described as the printing processes.

Published, non-prosecuted German patent application DE 39 38 055 A1, corresponding to U.S. Pat. No. 5,223,360, discloses the printing of safety features using printing inks that contain plate-shaped pigments. A medium that can be hardened and has pearlescent pigments is used. The orientation of the pigments is influenced from outside for example by UV radiation or magnetic fields. Thus a non-topological structure is created. No structuring of the surface of the printing ink (a structure of elevations and depressions) is described.

Published, non-prosecuted German patent application DE 103 04 805 A1 describes a safety feature that is created in a process of the printing industry and has a random distribution of effect pigments in the printing ink. Surface structures such as elevations are described as random features. The document describes the spraying on of uneven layers of varnish to create such a feature.

### SUMMARY OF THE INVENTION

It is accordingly an object of the invention to provide a method of creating a structured surface in the field of the printing industry which overcome the above-mentioned disadvantages of the prior art methods and devices of this general type. The invention provides a further and combinable method of creating a structured surface in the field of the printing industry, i.e. a method that potentially provides an improvement over the prior art inasmuch as it allows to create structured surfaces that are useful for safety features in a simple, cost-efficient way, in a manner integrated into the production of printed products, if possible. Moreover, it is a further or alternative object of the present invention to create an improved machine for creating such safety features.

In accordance with the invention, a method of creating a structured surface in the field of printing industry, wherein a liquid and particles are applied to a substrate and the liquid is provided with a surface structure is characterized by the fact that a random surface structure of the liquid and a random particle distribution is created by blowing a gas onto the unhardened liquid.

The application of the method of the invention has a number of advantages: the method provides a simple and simultaneously cost-efficient production of structured surfaces and of safety features that are based on structured surfaces because the only additional step that is required is blowing. Due to the fact that the invention is easy to put into practice and requires only few steps it can be easily integrated into the production process. The aforementioned advantages are based on the fact that blowing is a much simpler and much more cost-efficient step than embossing, for instance, because no expensive high-wear embossing tools are required.

In accordance with a preferred further development of the method of the invention which is advantageous in terms of the formation of random features, the blowing of the gas onto the liquid may create a random distribution of the positions of the particles.

In accordance with another preferred further development of the method of the invention which is advantageous in terms of the formation of random features, the blowing of the gas onto the liquid may create a random distribution of the orientation of the particles.

In accordance with a preferred further development of the present invention which is advantageous in terms of the formation of easily discernible and/or detectable random features, temperature-controlled, preferably heated blown air or infrared radiation in addition to blown air may be applied to the liquid to reduce the viscosity of the liquid preferably by heating and to assist in the random distribution of the particles (in terms of position and/or orientation). This may cause the formation of random waves or bubbles, for instance. A source of laser beams or microwaves may be used as a further enhancing factor to obtain a random distribution of the particles (in terms of position and/or orientation). As an alternative, it is possible to adjust the temperature of the substrate, preferably to heat the substrate.

In accordance with a preferred further development of the invention which is advantageous in terms of the formation of durable random features the liquid may be hardened after the blowing step using radiation, preferably ultraviolet radiation, infrared radiation, or electron radiation, laser radiation, microwave radiation and/or hot air to fix the random surface structure and the random particle distribution. In other words, whereas the means mentioned in the previous paragraph primarily aim at creating the randomization effect, the means mentioned in the present paragraph are primarily used to fix the randomized structure and make it durable.

In accordance with a preferred further development of the invention which is advantageous in terms of the desired optical effects such as gloss or glitter, the particles that are applied may be effect pigments selected from one of the following types of effect pigments: natural or synthetic interference pigments, pearlescent pigments, mica coated with a metal oxide, coated borosilicates, liquid crystals, small glass plates, glass beads, metallic effect pigments, small plastic plates, or small pieces of plastic film, and may have an effect that is discernible visually or by camera.

In accordance with a preferred further development of the method of the invention which is advantageous in terms of the possibility of using the features as a safety feature or a decorative feature the particles may create an effect that is discernible visually and/or by camera.

In accordance with a preferred further development of the method of the invention which is advantageous in terms of the formation of easily discernible and/or detectable random features a contrast-enhancing second liquid or a contrast-enhancing foil material/foil transfer material may additionally be applied to the substrate.

In accordance with the invention, a method of creating a safety feature as a proof of authenticity on a printed product or a product of the packaging industry contains the steps of applying a surface having random features to a substrate of the product in a locally limited feature region in accordance with a method described above with reference to the invention and creating a unique specimen.

In accordance with the invention, a machine processing printing material such as a printing press, in particular a sheet-fed rotary printing press for lithographic offset printing, for carrying out one of the aforementioned methods contains a device for applying a liquid with particles, a downstream blowing device for blowing on a gas to randomly structure the unhardened surface of the liquid and to randomly distribute the particles, and a further downstream device for fixing and/or hardening the randomly structured liquid.

Operating the machine of the invention has advantages as described above in the context of the method of the invention. For example, it is possible to create structured surfaces inline with simple, tried means in a cost-efficient way.

In accordance with a further development of the machine of the invention which is advantageous in terms of easily discernible and/or detectable random features the device for applying the liquid with particles may be a screen printing unit, and an upstream offset printing unit or cold-foil transfer unit may be provided which applies a contrast-enhancing second liquid or a contrast-enhancing foil transfer material.

The invention and the advantageous developments of the invention that have been described in combination with each other likewise present advantageous further developments of the invention. A preferred combination is, for instance, a pre-treatment of the substrate with black offset ink, the application of the liquid together with pearlescent particles in a screen printing process, the blowing of heated air, and the final hardening by UV radiation.

Other features which are considered as characteristic for the invention are set forth in the appended claims.

Although the invention is illustrated and described herein as embodied in a method of creating a structured surface in the field of the printing industry, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

The invention as such as well as further developments of the invention that are advantageous in constructional and/or functional terms will be described in greater detail below with reference to the associated drawings and based on at least one preferred exemplary embodiment. In the drawings, corresponding elements are identified by identical reference numerals.

### BRIEF DESCRIPTION OF THE SEVERAL VIEWS OF THE DRAWING

FIG. 1 is a diagrammatic, sectional view of a preferred exemplary embodiment of a machine according to the invention for processing printing material;

FIG. 2 is an enlarged sectional view of an applied structured liquid/particle layer according to the invention; and

FIG. 3 is a flow chart of a preferred exemplary embodiment of a method according to the invention.

### DETAILED DESCRIPTION OF THE INVENTION

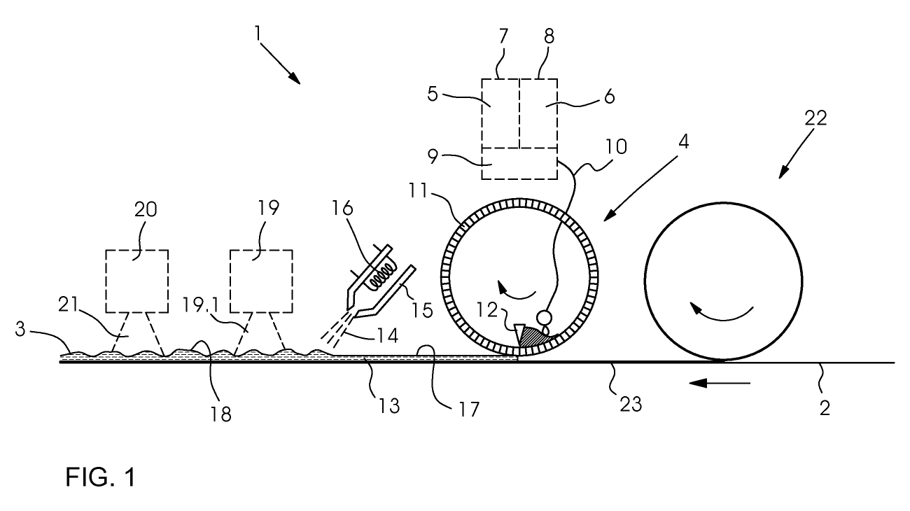

Referring now to the figures of the drawing in detail and first, particularly, to FIG. 1 thereof, there is shown a diagrammatic sectional view of a preferred exemplary embodiment of a machine 1 of the invention for processing printing material. Printing material 2 or a substrate, preferably paper (alternatively board or plastic) may be web-shaped or sheet-shaped and passes through a number of processing stations in the machine 1. The processing stations are used to create a structured surface 3 in a process of the printing industry in accordance with the invention.

The machine 1 includes a device 4 for applying a liquid 5 and for applying particles 6. The device 4 is preferably configured as a screen printing unit 4, in particular a rotary screen printing unit 4 to which a liquid is supplied from inside. A supply of liquid 5 is located in a container 7, and a supply of particles 6 is located in a separate container 8, from where the liquid 5 and the particles 6 are fed to a mixing device 9. The mix consisting of the liquid 5 and the particles 6 that has been created in this way is fed to the interior of a screen printing cylinder 11 in a lateral direction through a line 10. From there, it is applied to the substrate 2 using a blade 12 that interacts with the printing screen. Alternatively, other devices for applying the liquid 5 and for applying the particles 6 are usable such as a flexographic printing unit or a jet printing unit. In any case an important aspect is that the device is capable of applying a layer 13 of the liquid that is thick enough for subsequent structuring, preferably between approximately 50 μm and approximately 500 μm.

The liquid 5 is preferably a printing ink 5 or a varnish 5. The particles are preferably pearlescent pigments 6, mica 6 coated with a metal oxide, coated borosilicates 6, liquid crystals 6, small glass plates 6, glass beads 6 (for instance of different colors), metallic effect pigments 6, small plastic plates 6, or small pieces of plastic film 6. The particles 6 have an effect that is visually discernible, i.e. visible to the naked eye, or detectable by a camera, i.e. detectable in the optical spectral range. In other words, the particles 6 modify the optical impression of the applied liquid 5.

In accordance with the invention, a gas 14 is applied to the layer 13 of the applied liquid 5. For this purpose, the machine 1 is equipped with a device 15 for blowing a gas 14 onto the layer 13. The gas 14 that is used is preferably air 14. To control the temperature and thus to reduce the viscosity of the liquid 5 by heating, the gas 14 may be heated up before it is blown on. For this purpose, a heating device 16, preferably arranged inside the blower device 15, may be used. The heated liquid 5, which thus has a lower viscosity, is easier to structure by the applied gas 14, i.e. the pressure or flowing speed of the gas 14 that are required to obtain a sufficiently pronounced structuring of a surface 17 of the liquid or layer 13 can be lower. In this context, a sufficiently pronounced structuring is intended to indicate that the unevenness 18 (alternatively the mountains/valleys, structure of elevations and depressions, coarse structure) is formed in such a way that the optical impression is recognizably modified at least in sections by the structuring 19.

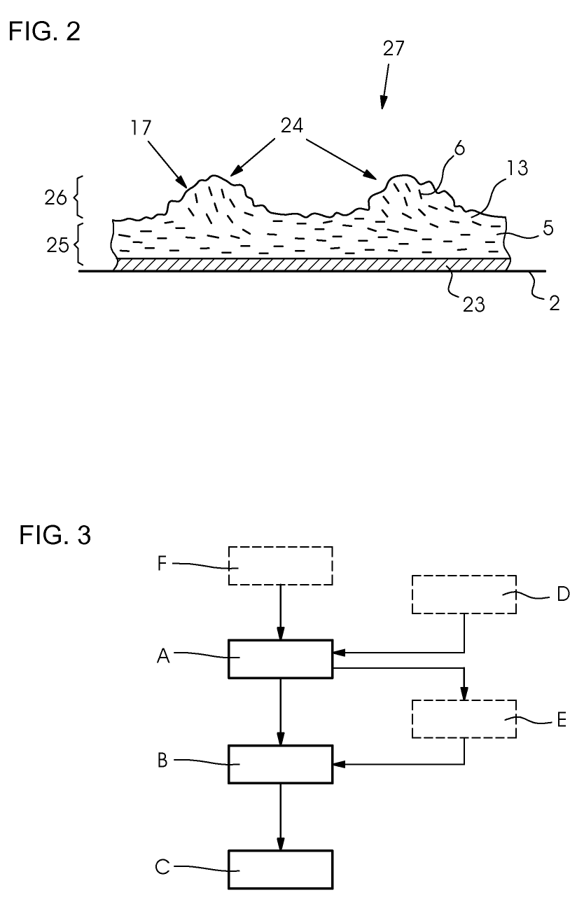

In accordance with the invention, the blowing of the gas 14 onto the unhardened and thus still deformable surface 17 of the liquid results in the creation of a random surface structuring 18 of the liquid 5 and of a random distribution of particles, i.e. two random features which together form a unique specimen (see FIG. 2). The random distribution of particles may be a random distribution of the positions of the particles and/or a random distribution of the orientations of the particles. When plate-shaped or flattened particles 6 are used, their location relative to the substrate 2 and their angle (of the plates) relative to the substrate 2 may be influenced in this way.

Moreover, in addition or as an alternative to the heating device 16, a separate heating device 19, preferably an infrared radiator 19, may be provided to heat the liquid 5 in the zone of action of the blower device 15.

The structured liquid coating 13 is finally moved downstream and fed to a subsequent device 20 for hardening the liquid. The device 20 is preferably a device which i) generates ultraviolet radiation, infrared radiation, or electron radiation and/or ii) generates hot air. The effect of generated radiation 22 or hot air 22 is to harden the liquid 5 and thus to fix the random surface structuring 18 and the random particle distribution in the hardened liquid 5.

To enhance the optical effect of the liquid/particle layer 13, an upstream lithographic offset printing unit 22 or a cold-foil transfer unit 22 may be provided to apply a contrast-enhancing second liquid 23 or a contrast-enhancing foil transfer material 23. Preferably, a dark-colored or black printing ink is applied. Alternatively, a substrate provided with a dark or black color or coating may be used.

FIG. 2 is an enlarged sectional view of the applied and structured liquid/particle layer 13 of the invention. As can be seen, elevations 24 containing particles 6 form in the liquid due to the blowing. The position and orientation of the particles in the elevations 6 may be influenced and thus modified by the blowing action. As a result of the process carried out in accordance with the invention, the particles 6 are randomly distributed in terms of their position and orientation. These two aspects influence the optical appearance of the structured surface 17 and may be used for purposes of optical design.

What can also be seen is that the particles 6 in a lower region 25 of the coating 13 tend to be aligned in parallel with the substrate and thus tend to be distributed regularly rather than randomly. That is to say that the structuring and random manipulation preferably occurs in an upper region 26 of the coating 13. In other words, the manipulation of an essential portion of the particles 6 by the blowing action causes the angular orientation of the respective planes of the particles relative to the plane of the substrate to be modified and to vary more widely as compared to a more narrow distribution of angular orientations created by a mere application, a fact which becomes optically discernible in particular in the case of flat particles 6. The effect may, for example, be that the structural elevations 24, which may also be referred to as “mountains”, may have a lighter or otherwise modified color appearance as compared to what is referred to as the “valleys” and may thus be more readily discerned visually or detected. In a more concrete further embodiment, essentially flat particles 6 that are present in the initially mainly flat layer of liquid 13 and aligned essentially in parallel with the substrate 2 are caused to form the structural elevations 24 thus created by the blowing action and are there influenced in terms of their orientation such that an essential portion of these particles 6 is no longer aligned in parallel with the substrate 2.

The use of plate-shaped particles 6 whose orientation is widely distributed at random due to the blowing action has an optical effect due to different, widely varying angular orientations which have an influence on the visual impression.

In addition to creating decorative features on printed products, the effects that are created in this way may also be used in the context of a method of creating a safety element 27 on a printed product or a product of the packaging industry as a proof of authenticity by applying a surface containing random features to a locally limited feature region on the substrate 2 of the product, thus creating a unique specimen. The random features result from the random structuring of the surface 17 of the liquid 5 and from the random distribution of the particles 6 in the liquid. A safety feature 27 produced in accordance with the invention is difficult to reproduce by a potential counterfeiter because it includes an outer open three-dimensional structuring of the surface 17 (“mountain/valley effect”) and a hidden inner structuring of the particle distribution (variable “glitter effect”). Simple copying of the feature 27 on current conventional copying machines is thus impossible.

A non-illustrated control unit may be used to control the supply (pressure, amount, type of gas) of the gas 14 and/or to control the temperature of the liquid 5 and thus to control the effects that will be produced. For instance, a high-impulse gas expulsion may result in the creation of higher structural elevations 24 and consequently in the creation of more pronounced visual effects.

The structuring of the surface of the liquid does not only have an optical effect, but also a haptic effect, which may likewise be used as a simple first authenticity test for merchandise.

FIG. 3 is a flow chart of a preferred embodiment of a method of the invention of creating a structured surface in a process of the printing industry wherein a liquid and particles are applied to a substrate and the liquid is provided with a surface structure.

In a process step A (application), the liquid 5 and the particles 6 are applied to the substrate 2, preferably together, for instance in the form of a mixture, by a rotary screen printing unit 4.

In a process step B (blowing), a gas 14 is blown onto the layer 13 of liquid or rather its surface 17, thus creating a random structuring 18 of the surface 17 and a random distribution of the particles 6 at least in a region 26 close to the surface of the layer 13.

In a process step C (hardening), the layer 13 of liquid which has been previously treated is hardened, preferably using a UV unit 20, to fix and essentially permanently set both the structure 18 (topography) of the surface 17 and the distribution of the included particles 6.

In an optional process step D (mixing), the particles 6 are admixed to the liquid 5 and are made available to a device 4 for applying the mix in accordance with process step A.

In an optional process step E (heating), the liquid 5 is heated up either directly by a heat source 19 such as an IR radiator or indirectly by a heated gas 14.

In an optional process step F (pre-treatment), a contrast-enhancing second liquid 23 or a contrast-enhancing foil transfer material 23 is applied to the substrate 2 and, if necessary or desired, hardened, preferably by UV radiation, prior to the application of the liquid/particle layer 13.

1. A method of creating a structured surface in a printing industry process, which comprises the steps of:
applying a liquid and particles to a substrate; and
creating a random surface structuring of the liquid and a random distribution of the particles by blowing a gas onto the liquid in an unhardened state.

2. The method according to claim 1, which further comprises achieving the random distribution of particle positions by blowing the gas onto the liquid.

3. The method according to claim 1, which further comprises achieving a random distribution of particle orientations by blowing the gas onto the liquid.

4. The method according to claim 1, which further comprises applying one of heated blown air or infrared radiation in addition to the air blown onto the liquid, thus reducing a viscosity of the liquid by heating.

5. The method according to claim 1, wherein after performing the blowing step, hardening the liquid using at least one of radiation or hot air, thus fixing the random surface structuring and a random particle distribution.

6. The method according to claim 1, wherein the particles applied are effect pigments selected from the group consisting of natural interference pigments, synthetic interference pigments, pearlescent pigments, mica coated with a metal oxide, coated borosilicates, liquid crystals, small glass plates, glass beads, metal effect pigments, small plastic plates, and small pieces of plastic film, the particles create an effect that is discernible visually and/or by a camera.

7. The method according to claim 1, which further comprises applying one of an additional contrast-enhancing second liquid or an additional contrast-enhancing foil transfer material to the substrate.

8. The method according to claim 5, which further comprises selecting the radiation from the group consisting of ultraviolet radiation, infrared radiation and electron radiation.

9. A method for creating a safety feature on a printed product or a product of the packaging industry for a purpose of proving authenticity, which comprises the steps of:
applying a liquid and particles to a locally limited feature region on a substrate of the product; and
creating a random surface structuring of the liquid and a random distribution of the particles by blowing a gas onto the liquid in an unhardened state resulting in a surface having random features thus creating a unique specimen.

10. A machine for processing printing material, the machine comprising:
a first device for applying a liquid with particles;
a second device for blowing a gas, thus creating a random structure in an unhardened surface of the liquid and a random distribution of the particles, said second device disposed downstream of said first device; and
a third device for fixing and/or hardening a randomly structured liquid, said third device disposed downstream of said second device.

11. The machine according to claim 10,
wherein said first device for applying the liquid with the particles is a screen printing unit;
further comprising a unit selected from the group consisting of an offset printing unit and cold-foil transfer unit for applying a contrast-enhancing second liquid or a contrast-enhancing foil transfer material, said unit disposed upstream of said first unit.

12. The machine according to claim 10, wherein the machine is selected from the group consisting of printing presses and sheet-fed rotary printing presses for lithographic offset printing.
